(19) United States
(12) Patent Application Publication
(10) Pub. No.: US 2026/0300367 A1
(43) Pub. Date: Oct. 1, 2026

(54) UNSTRUCTURED DOCUMENT TYPE CLASSIFICATION WITH VECTOR SPACE SIMILARITY TO LLM GENERATED DOCUMENTS

(71) Applicant: Rubrik, Inc., Palo Alto, CA (US)

(72) Inventors: Dan Eldad, Tel Aviv (IL); Ori Lahav, Jerusalem (IL); Muraliraja Muniraju, Fremont, CA (US); Inesa Geysman, Tel Aviv (IL); Noa Mishanya, Ness Ziona (IL)

(21) Appl. No.: 19/092,075

(22) Filed: Mar. 27, 2025

(51) Int. Cl. G06F 16/35; G06F 16/334; G06F 40/20

(52) U.S. Cl. CPC G06F 16/35; G06F 16/3347; G06F 40/20

(57) ABSTRACT

Methods, systems, and non-transitory computer readable media are configured to perform operations comprising: based on a large language model, generating, by a computing system, at least one document of a predetermined document type associated with sensitive data; generating, by the computing system, embedding vectors associated with documents of the predetermined document type including the at least one document; based on the embedding vectors, determining, by the computing system, a vector corresponding to the predetermined document type; and classifying, by the computing system, a second document that is unstructured as the predetermined document type based on satisfaction of a similarity threshold between an embedding vector associated with the second document and the vector corresponding to the predetermined document type.

### FIELD OF THE INVENTION

The present technology relates to the field of data management. More particularly, the present technology relates to document type classification based on documents generated by a large language model (LLM).

### BACKGROUND

An organization can have large volumes of files stored in various environments. For example, files can be stored in the cloud and on premises. Because of the potential wide distribution of the files and variation in their contents, different types of data contained in the files can be difficult to detect and classify.

### SUMMARY

Various embodiments of the present technology can include systems, methods, and non-transitory computer readable media configured to perform operations comprising: based on a large language model, generating, by a computing system, at least one document of a predetermined document type associated with sensitive data; generating, by the computing system, embedding vectors associated with documents of the predetermined document type including the at least one document; based on the embedding vectors, determining, by the computing system, a vector corresponding to the predetermined document type; and classifying, by the computing system, a second document that is unstructured as the predetermined document type based on satisfaction of a similarity threshold between an embedding vector associated with the second document and the vector corresponding to the predetermined document type.

In some embodiments, the large language model is provided with a prompt indicating the predetermined document type.

In some embodiments, the vector is a centroid that is maintained in a database.

In some embodiments, the operations further comprise: determining that a cluster formed by the embedding vectors associated with documents of the predetermined document type does not satisfy a cohesiveness threshold; and based on the large language model, generating additional documents of the predetermined document type.

In some embodiments, the operations further comprise: determining that a cluster formed by the embedding vectors associated with documents of the predetermined document type does not satisfy a separation threshold in relation to a second cluster formed by embedding vectors associated with documents of a second predetermined document type; and based on the large language model, generating additional documents of the predetermined document type.

In some embodiments, a plurality of vectors including the vector correspond to a plurality of predetermined document types including the predetermined document type.

In some embodiments, the classifying comprises: generating the embedding vector associated with the second document; determining the satisfaction of the similarity threshold based on cosine similarity between the embedding vector associated with the second document and the vector corresponding to the predetermined document type; and determining the second document is associated with the predetermined document type.

In some embodiments, the operations further comprise: based on the large language model, generating a plurality of documents of a new document type in the absence of preexisting documents of the new document type; generating embedding vectors associated with the plurality of documents of the new document type; and based on the embedding vectors associated with the plurality of documents of the new document type, determining a vector corresponding to the new document type.

In some embodiments, the operations further comprise: based on a density based clustering algorithm, clustering embedding vectors associated with a plurality of documents from a data environment to generate at least one cluster associated with a new document type; determining a vector corresponding to the new document type; providing a first subset of documents from the plurality of documents associated with embedding vectors of the at least one cluster to the large language model to generate a label descriptive of the new document type.

In some embodiments, the operations further comprise: determining a second subset of documents from the plurality of documents not associated with embedding vectors of the at least one cluster; associating the second subset of documents with at least one predetermined document type of a plurality of predetermined document types or noise.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example functional block diagram relating to a data management system for generation of vectors associated with various document types, according to an embodiment of the present technology.

FIG. 2 illustrates an example prompt for generating documents of a specified document type, according to an embodiment of the present technology.

FIG. 3 illustrates an example functional block diagram relating to the data management system for classification of documents according to various predetermined document types, according to an embodiment of the present technology.

FIG. 4 illustrates an example functional block diagram relating to the data management system for determination of a vector corresponding to a new document type, according to an embodiment of the present technology.

FIGS. 5A-5B illustrate an example functional block diagram relating to the data management system for determination of a vector corresponding to a new custom document type, according to an embodiment of the present technology.

FIG. 6 illustrates a method, according to an embodiment of the present technology.

FIG. 7 illustrates an example of a computing environment in which the data management system can be implemented, according to an embodiment of the present technology.

FIG. 8 illustrates an example computer system, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

An organization can have large volumes of documents or files stored in various environments. For example, files can be stored in the cloud and on premises. Because of the potential wide distribution of the files and variation in their contents, different types of data contained in the files can be difficult to detect and classify. The difficulty can be especially challenging with respect to detection and classification of certain types of data in unstructured data.

One type of data is sensitive data. Unstructured data in a document or file that is sensitive can be difficult to classify. The document can be considered sensitive based on its content essence as contained or reflected in the file. As a result, conventional techniques such as pattern matching to identify personally identifiable information (PII) or other particular expressions of data in a document can be unable to properly classify the document as sensitive. Other conventional machine learning techniques to classify documents also have significant disadvantages. For example, conventional utilization of a neural network as a document classifier can require massive amounts of prelabeled documents to adequately train the neural network, entailing significant expense in terms of effort and time. Moreover, certain types of documents, such as documents containing sensitive data, are difficult to access, much less aggregate to the extent required for proper training of machine learning models. As another example, large language models (LLMs) can potentially be utilized to classify documents as different types of data, such as sensitive data. However, the classification of a single document by an LLM can require a significant expenditure of computational resources in contrast to other tasks that the LLM can more efficiently perform. To utilize an LLM to classify a potentially voluminous amount of documents of an organization therefore can be cost prohibitive. In addition, when provided with a limited number of selected labels, an LLM can often exhibit an undesirable tendency to assign one of the labels to a document even when the document is not properly described or otherwise associated with any of the labels.

An improved approach rooted in computer technology overcomes the foregoing and other disadvantages associated with conventional approaches specifically arising in the realm of computer technology. With the present technology, documents (or files) of a predetermined or predefined document type can be generated by a machine learning model, such as a large language model (LLM), in response to appropriate prompting. For example, the documents can be or include unstructured data. The predetermined document type can relate to, for example, sensitive data. The generated documents can be transformed into embedding vectors in a vector space. Embedding vectors of documents, including the generated documents, can form a cluster. A vector, such as a centroid, can be determined for the cluster. The centroid can represent or otherwise be associated with the predetermined document type. In this manner, the LLM can be used to generate documents for the determination of a plurality of centroids representative of a baseline of predetermined document types. When a document is to be classified, an embedding vector associated with the document can be considered in relation to the plurality of centroids. The document can be classified as the predefined document type associated with the centroid closest to the embedding vector.

In some embodiments of the invention, new document types can supplement predetermined document types. For example, a new document type can be specified by a user. If there is an insufficient number of preexisting documents of the new document type, a machine learning model, such as an LLM, can generate documents based on a prompt indicating the new document type. As described, a centroid can be determined for the new document type. In another example, new custom document types arising from a customer environment can be supported. Documents from the customer environment can be transformed into embedding vectors. Clustering can be applied to the embedding vectors. For example, clustering can be performed by a density based clustering algorithm. When embedding vectors that are not associated with preexisting centroids form a new cluster, a new custom document type associated with the new cluster can be determined.

The present technology can leverage the inherent capabilities and efficiencies of an LLM in an overall system to classify documents of different document types. Rather than rely on an LLM to perform the computationally expensive task of classification, the present technology can utilize the LLM to very efficiently generate documents of certain document types. An LLM can be considered to be based on proximity of texts in a vector space. Thus, to utilize an LLM to generate a specific type of document can be considered reverse engineering the ability of the LLM to understand what the specific type of document is. This utilizes the unique capabilities of the LLM without having to query the LLM to classify each document. In addition, the present technology uses an innovative combination of unsupervised learning (e.g., LLMs, embedding models, vector space similarity) with supervised learning (e.g., comparison to a ground truth of baseline embeddings). This allows efficient classification of documents at a scale of billions of documents in a single customer environment without compromising accuracy. These and other inventive features of various embodiments of the present technology are discussed in more detail herein.

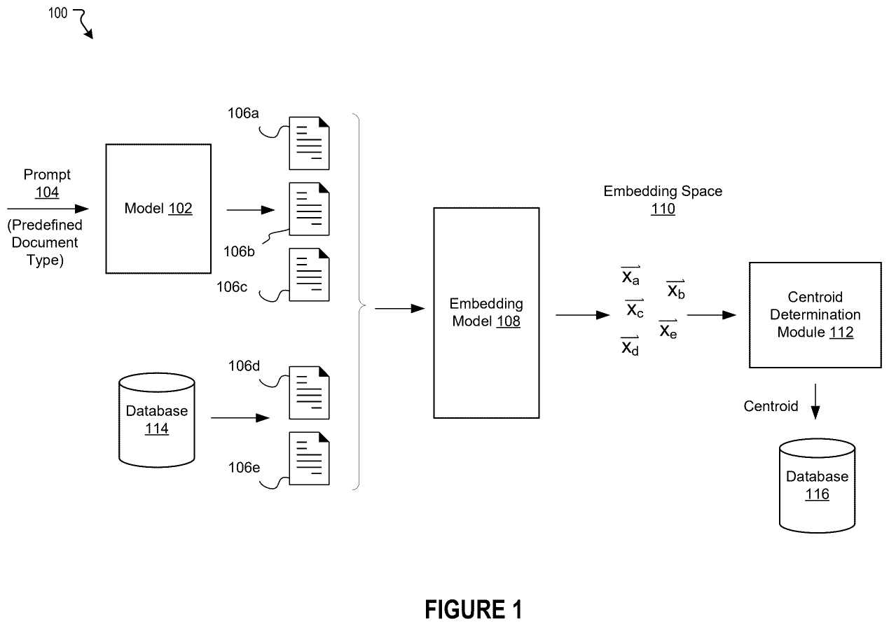

FIG. 1 illustrates an example functional block diagram 100 relating to functionality of a data management system for generation of vectors associated with various document types, according to an embodiment of the present technology. In the functional block diagram 100, different vectors (e.g., centroids) are generated for document classification based on embedding vectors associated with documents of different document types. In some embodiments, the documents classified by the data management system can be or include unstructured data. The data management system can classify or label documents as different predetermined document types as well as new document types. In some embodiments, the predetermined document types and the new document types can be different types of documents containing sensitive data. For example, the predetermined document types can relate to any categories of documents constituting or containing sensitive data. While document types relating to sensitive data are referenced in various examples herein, the present technology can also apply to other document types relating to other subject matter apart from sensitive data.

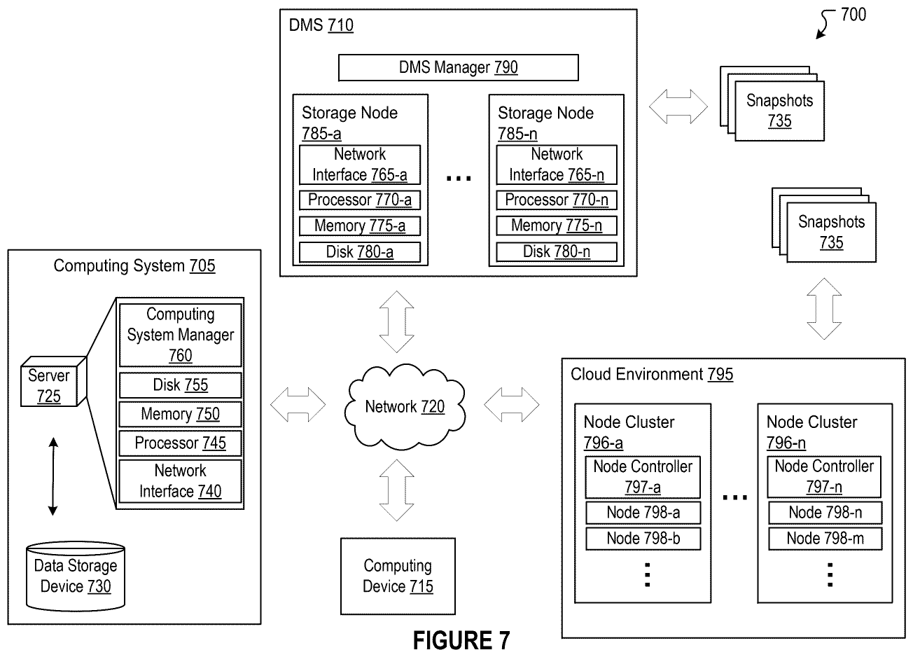

The data management system can be implemented in a variety of computing environments. In some embodiments, the data management system can be implemented as functionality in or for a data security posture management (DSPM) environment. In some embodiments, the data management system can be implemented or controlled, in whole or in part, in a cloud computing environment associated with a data management service (DMS) 710, as discussed in more detail in connection with FIG. 7. For example, the data management system can be implemented as a service for a customer of an entity in control of the DMS 710. In some embodiments, the data management system can be implemented or controlled by a second entity having a particular type of relationship with the entity in control of the DMS 710, such as a customer of the entity in control of the DMS 710. For instance, the data management system can be implemented, in whole or in part, in a cloud account or an outpost account of the second entity.

In some instances, one entity (e.g., organization) can control, operate, maintain, perform, or provide all of the components and features of the data management system of the present technology, as described herein. In some instances, one entity can control, operate, maintain, perform, or provide some of the components and features of the present technology while one or more other entities can control, operate, maintain, perform, or provide other of the components and features. In some instances, some or all components and features of the present technology can be implemented in a cloud environment. In some instances, some or all components and features of the present technology can be implemented on premises. In some instances, the present technology can be implemented by a server system. In some embodiments, the functionality of the present technology can be distributed between a server system and an application running on a client computing device. Many variations are possible.

As shown in the example of the functional block diagram 100, the data management system can include a model 102, a prompt 104, documents 106a-c, an embedding model 108, an embedding space (or vector space) 110, a centroid determination module 112, a database 114, documents 106d-e, and a database 116. The present technology, which can include the components and features (e.g., modules, elements, databases, functionalities, operations, etc.) herein discussed or illustrated in the various figures, can have many variations. Different implementations of the present technology may include additional, fewer, integrated, or different components and features. Some components or features may not be shown so as not to obscure relevant details. In various embodiments, one or more of the components and features described herein can be implemented in any suitable combinations.

The model 102 can generate one or more documents 106a-c of a predetermined document type. While three documents are illustrated as an example, any suitable number of documents can be generated. The predetermined document type can be a document type of a plurality of document types known to an entity in control of the data management system. For example, plurality of predetermined document types can relate to sensitive data. For instance, the plurality of predetermined document types relating to sensitive data can be any categories of documents constituting or containing sensitive data, such as tax forms, incident reports, intellectual property agreements, employee paychecks, accounting records, invoices or receipts, audit reports, resumes, employment agreements, and the like. Any number of predetermined document types relating to sensitive data is possible (e.g., 5, 10, 25, 30, 50, etc.). Sensitive data is an example of subject matter reflected in predetermined document types that can be generated by the model 102. While many illustrations set forth herein relate to sensitive data, the plurality of predetermined document types can relate to subject matter other than sensitive data.

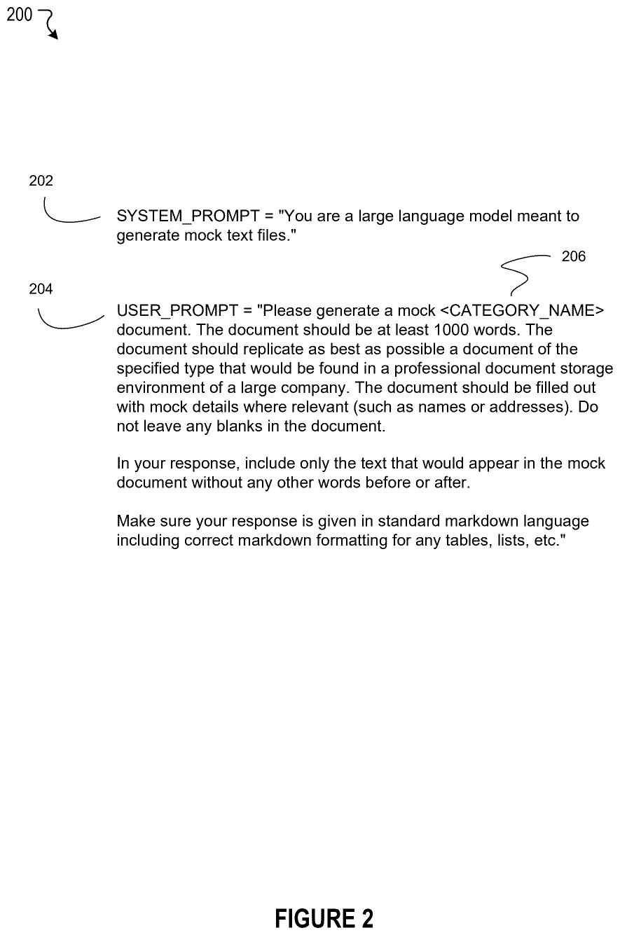

The model 102 can be any model suitable for generating documents according to specifications of a prompt 104. The prompt 104 can be configured to cause the model 102 to generate documents of the predetermined document type. The prompt 104 is discussed in more detail below in connection with FIG. 2. The model 102 can be or include any type of generative AI model or foundation model, such as a large language model (LLM). The model 102 can be capable of performing general purpose language generation and other natural language processing tasks associated with artificial intelligence. The model 102 can be pretrained based on vast amounts of textual data and deep learning techniques. The model 102 can implement a transformer architecture, such as generative pre-trained transformer. The model 102 can be proprietary or source available. The model 102 can be maintained on the premises of an organization in control of the data management system or utilized by the data management system as a service hosted by another organization. Many variations of the model 102 are possible. In some embodiments, model functionality as described herein can be performed by a plurality of models while, in other embodiments, model functionality can be performed by one model. References to models set forth herein can utilize one type of model in some embodiments or a combination of different types of models in other embodiments. Many variations are possible.

The documents 106d-e of the predetermined document type can be acquired. The documents 106d-e can be preexisting documents obtained from the database 114. For example, the documents 106d-e and labels indicating their association with the predetermined document type can be stored in the database 114. For example, the documents 106d-e can be acquired from, for example, a database, scan, or backup of data maintained for or otherwise associated with an organization, as discussed in more detail in connection with FIG. 7. While two documents are illustrated as an example, any suitable number of documents of the predetermined document type can be obtained from the database 114.

The documents 106a-e can be representative of the predetermined document type. While the document 106a-e are illustrated as five documents as an example, the number of the documents 106 a-e can be any suitable number (e.g., 5, 10, 25, 100, 200, etc.) that is representative of the associated predetermined document type. The documents 106a-e can be provided to the embedding model 108. The embedding model 108 can be any suitable embedding model that can transform the documents 106a-e into embedding vectors in the embedding space 110 in which embedding vectors associated with similar documents are located relatively closer to one another and embedding vectors associated with dissimilar documents are located relatively farther from one another. For example, the embedding model 108 can be all-mpnet-base-v2 or a different embedding model (e.g., Sentence-BERT, Universal Sentence Encoder, T5, etc.). As shown, document 106a, document 106b, document 106c, document 106d, and the document 106e can be transformed into, respectively, embedding vector [symbol] , embedding vector [symbol] , embedding vector [symbol] , embedding vector [symbol] , and embedding vector [symbol] . As shown, the embedding vectors [symbol] form a cluster based on their common document type. A clustering algorithm need not be performed.

The sufficiency of the cluster formed by the embedding vectors [symbol] can be determined. For example, a value (or score) of intra-cluster cohesiveness of the embedding vectors [symbol] (e.g., within-cluster sum of squares (WCSS), intra-cluster variance, average intra-cluster distance, etc.), a value of inter-cluster separation between the cluster formed by the embedding vectors [symbol] and other clusters (e.g., centroid distance, minimum pairwise distance, etc.), or a value for both intra-cluster cohesiveness and inter-cluster separation (e.g., silhouette score, etc.) can be determined. A value of intra-cluster cohesiveness can indicate how tightly grouped (or close knit) the embedding vectors [symbol] are in the embedding space 110 and thus consistency or uniformity of the semantic meanings of documents represented by the embedding vectors [symbol] . A value of inter-cluster separation can indicate to what degree different clusters are semantically distinct from one another to support various tasks including accurate classification among various document types.

A determined value of the sufficiency of the cluster can be compared with a threshold value. A threshold value of intra-cluster cohesiveness can be selected based on a desired level of similarity among documents to be associated with the predetermined document type. A threshold value of inter-cluster separation can be selected based on a desired level of distinctness between the predetermined document type and other predetermined document types. A threshold value of combined intra-cluster cohesiveness and inter-cluster separation can be selected based on a desired level of similarity among documents to be associated with the predetermined document type as well as a desired level of distinctness between the predetermined document type and other predetermined document types. When a value satisfies an applicable threshold (e.g., threshold value of intra-cluster cohesiveness, threshold value of inter-cluster separation, threshold value of combined intra-cluster cohesiveness and inter-cluster separation), the centroid determination module 112 can generate a vector associated with the cluster. For example, the vector can be an average vector (e.g., centroid) of the embedding vectors [symbol] . The centroid can be representative of or otherwise associated with the predetermined document type. The centroid can be maintained in the database 116. For example, a label descriptive of the predetermined document type also can be maintained in the database 116.

When a determined value does not satisfy a corresponding threshold value (e.g., threshold value of intra-cluster cohesiveness, threshold value of inter-cluster separation, threshold value of combined intra-cluster cohesiveness and inter-cluster separation), one or more additional document(s) of the predetermined document type can be again generated by the model 102. The additional documents can supplement or replace previously generated documents. The embedding model 108 can generate a new cluster of embedding vectors based on documents including the additional documents. As discussed, the sufficiency of the new cluster can be determined. Additional documents can be iteratively generated by the model 102 in the manner described until a value relating to sufficiency of a formed cluster satisfies the applicable threshold value. Then, as discussed, a new centroid can be generated for the cluster, which along with an associated label, can be stored in the database 116.

In some embodiments, if a threshold value of inter-cluster separation for clusters associated with predetermined document types is not satisfied, the clusters can be selectively adapted. For example, if a first cluster and a second cluster are in undesirably close proximity to one another, the embedding vectors of the first cluster and the embedding vectors of the second cluster can be combined into and represented by a resulting combined cluster. The combined cluster can replace the first cluster and the second cluster. The combined cluster can be identified with a label that is descriptive of the predetermined document types associated with the first cluster and the second cluster. For example, the label for the combined cluster can be a first label associated with the first cluster when the first label is descriptive of both the predetermined document type associated with the first cluster and the predetermined document type associated with the second cluster. As another example, the label can be a new label descriptive of both the predetermined document type associated with the first cluster and the predetermined document type associated with the second cluster.

In a manner similar to that described for the predetermined document type, a plurality of centroids can be determined for clusters of embedding vectors associated with documents of a plurality of predetermined document types. The documents can include but are not limited to documents of various predetermined document types generated by the model 102. Each of the plurality of centroids can be representative of a respective corresponding predetermined document type. The plurality of centroids collectively can represent a baseline of predetermined document types. The plurality of centroids can be stored along with a label descriptive of the corresponding predetermined document type. In some embodiments, some or all of the embedding vectors associated with clusters represented by centroids can be stored in a database. In some embodiments, some or all of the embedding vectors of predetermined document types need not be stored or can be deleted after determination of a centroid representative of a cluster with which the embedding vectors are associated.

FIG. 2 illustrates an example prompt 200 for generating documents of a specified document type, according to an embodiment of the present technology. In some embodiments, the prompt 200 can be the prompt 104. The prompt 200 can be engineered and configured as a generation prompt including a system prompt 202 and a user prompt 204. The system prompt 202 can include a statement regarding behavioral framing in relation to generation of documents (e.g., “mock text files”). The user prompt 204 can include various elements, such as an instruction, input data, an output specification, and constraints. The user prompt 204 can include a field 206 (e.g., “Category_Name”) in which a document type of documents to be generated (e.g., label) can be specified. As shown, the user prompt 204 can instruct generation of a single document. In the example shown, the prompt 200 (i.e., zero shot) does not include an example of documents to be generated. Many variations are possible.

The prompt 200 can be provided to the model 102 to generate a document of the document type specified in the field 206. The prompt 200, including the system prompt 202 and the user prompt 204, can be provided to the model 102 each time a document of a specified document type is to be generated. As just one example, if three documents of a document type are to be generated, the prompt 200, including the system prompt 202 and the user prompt 204 with the document type (e.g., label) specified in the field 206, can be provided to the model 102 to generate a first document of the document type; the prompt 200, including the system prompt 202 and the user prompt 204 with the document type specified in the field 206, can be provided to the model 102 to generate a second document of the document type; and, the prompt 200, including the system prompt 202 and the user prompt 204 with the document type specified in the field 206, can be provided to the model 102 to generate a third document of the document type. The prompt 200 can reflect engineering and configuration to cause accurate generation of documents that appear authentic, correctly reflect the specified document type, and are not identical to one another.

When documents of other document types are to be generated, the prompt 200, including the system prompt 202 and the user prompt 204, can remain unchanged except for the document type (e.g., label) specified in the field 206. For example, assume documents of a first document type have been generated based on the prompt 200. Assume further that documents of a second document type are to be generated. To generate the documents of the second document type, the field 206 can be updated to specify the second document type. The prompt 200 otherwise can remain the same and otherwise does not change when generating documents of the second document type or other additional document types.

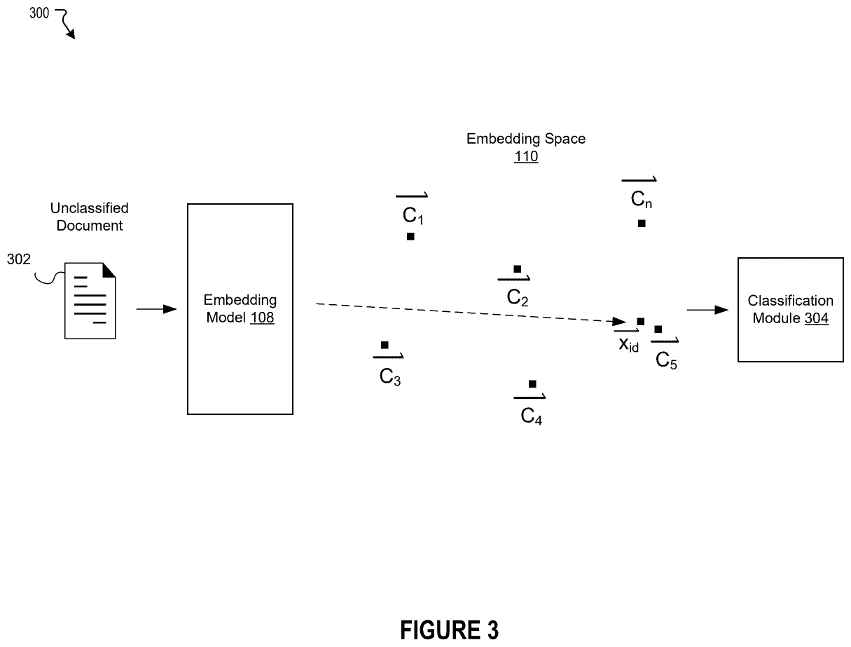

FIG. 3 illustrates an example functional block diagram 300 relating to the data management system for classification of documents according to various predetermined document types, according to an embodiment of the present technology. As shown in the example of the functional block diagram 300, the data management system can include a document 302, the embedding model 108, the embedding space (or vector space) 110, and a classification module 304. The document 302 can be an incoming document that is unclassified. For example, the document 302 can be or include unstructured data. Unstructured data can be acquired from, for example, a database, scan, or backup of data maintained for or otherwise associated with an organization, as described in more detail in relation to FIG. 7. Unstructured data can refer to data that is free form. Unstructured data can be included in documents containing substantial amounts of text without associated metadata. Documents containing unstructured data can include, for example, documents generated from software applications such as Word, Acrobat, Google Docs, etc. In contrast, structured data can refer to any type of data organized in a fixed format or schema that specifies the structure and types of data. For example, structured data can include labels, tags, descriptors, keys, or other types of metadata of a document as well as a corresponding portion (e.g., value, section, etc.) or the entirety of the document associated with the metadata. The document 302 can be provided to the embedding model 108.

The embedding model 108 can generate an embedding vector [symbol] associated with the document 302 in the embedding space 110. The embedding space 110 can include centroids [symbol] , where n can be any positive integer indicating a number of recognized document types (e.g., predetermined document types) that can constitute a baseline. Each centroid of the centroids [symbol] can be representative of or otherwise associated with a corresponding distinct document type. The classification module 304 can determine the location of the embedding vector [symbol] in relation to the centroids [symbol] . The classification module 304 can determine, as shown, that the location of the embedding vector [symbol] in the embedding space 110 is nearest to the centroid [symbol] . The classification module 304 can determine the similarity between the embedding vector [symbol] and the centroid [symbol] . The classification module 304 also can compare the similarity between the embedding vector [symbol] and the centroid [symbol] with a similarity threshold value. The similarity threshold value can be configurable. The similarity threshold value can be a threshold value of cosine similarity or other metric reflecting embedding vector similarity or proximity in the embedding space 110. If the similarity between the embedding vector [symbol] and the centroid [symbol] satisfies (e.g., is greater than or equal to) the similarity threshold value, the embedding vector [symbol] can be determined to correspond to the predetermined document type associated with the centroid [symbol] . Thus, the document 302 can be associated with or classified as the predetermined document type associated with the centroid [symbol] . In a manner similar to classification of the document 302, any number of unclassified documents can be classified as one of a plurality of predetermined document types.

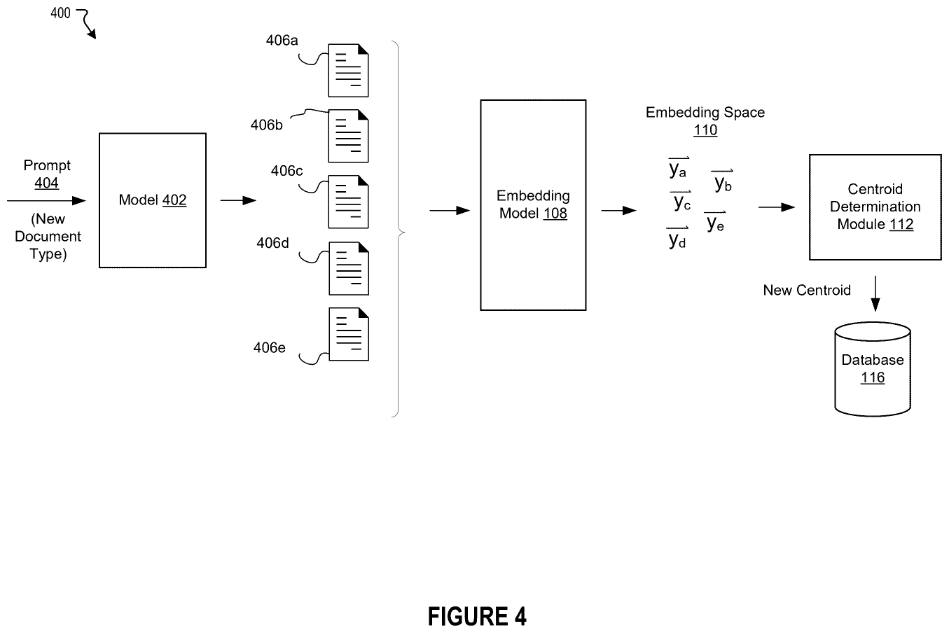

FIG. 4 illustrates an example functional block diagram 400 relating to the data management system for determination of a vector corresponding to a new document type, according to an embodiment of the present technology. For example, the new document type can be associated with sensitive data. In some embodiments, the new document type can be defined by a user of the data management system. As shown in the example of the functional block diagram 400, the data management system can include a model 402, a prompt 404, documents 406a-e, the embedding model 108, the embedding space (or vector space) 110, the centroid determination module 112, and the database 116.

The model 402 can generate one or more documents 406a-e of a new document type. While five documents are illustrated as an example, any suitable number of documents can be generated. The model 402 can be any model suitable for generating documents according to specifications of the prompt 404. The model 402 can be or include any type of generative AI model or foundation model, such as a large language model (LLM). In some embodiments, the model 402 and the model 102 can be the same model. The prompt 404 can be configured to cause the model 402 to generate documents of the new document type. In some embodiments, the prompt 404 and the prompt 104 can be the same prompt (e.g., the prompt 200) except the new document type can be specified in the prompt 404 instead of the predetermined document type specified in the prompt 104. In some embodiments, the prompt 404 and the prompt 104 can be the same prompt except 1) the new document type can be specified in the prompt 404 instead of the predetermined document type specified in the prompt 104 and 2) the prompt 404 can include an additional description of the new document type in or as a sub-prompt, paragraph, or other section in the prompt 404.

Documents, including the documents 406a-e, of the new document type can be provided to the embedding model 108. In some embodiments, only the documents 406a-e of the new document type can be provided to the embedding model 108 to generate a new centroid for the new document type. In some embodiments, the documents 406a-e of the new document type and preexisting documents of the new document type can be provided to the embedding model 108 to generate a new centroid for the new document type. While five documents 406a-e are illustrated as an example, any suitable number of documents of the new document type can be provided to the embedding model 108.

The embedding model 108 can transform the documents 406a-e of the new document type into embedding vectors [symbol] in the embedding space 110, as shown. A cluster formed by the embedding vectors [symbol] can be analyzed. As described herein, the sufficiency of the cluster formed by the embedding vectors [symbol] - [symbol] in relation to intra-cluster cohesiveness and inter-cluster separation from other clusters, such as clusters corresponding to predetermined document types, can be determined. If applicable threshold values are satisfied by the cluster formed by the embedding vectors [symbol] , the centroid determination module 112 can generate a vector, such as a new centroid, for the cluster. The new centroid can be representative of or otherwise associated with the new document type. The new centroid along with a descriptive label can be stored in the database 116. The new document type can be added to the baseline of predetermined document types to result in an increased set of document types to which unclassified documents can be potentially classified.

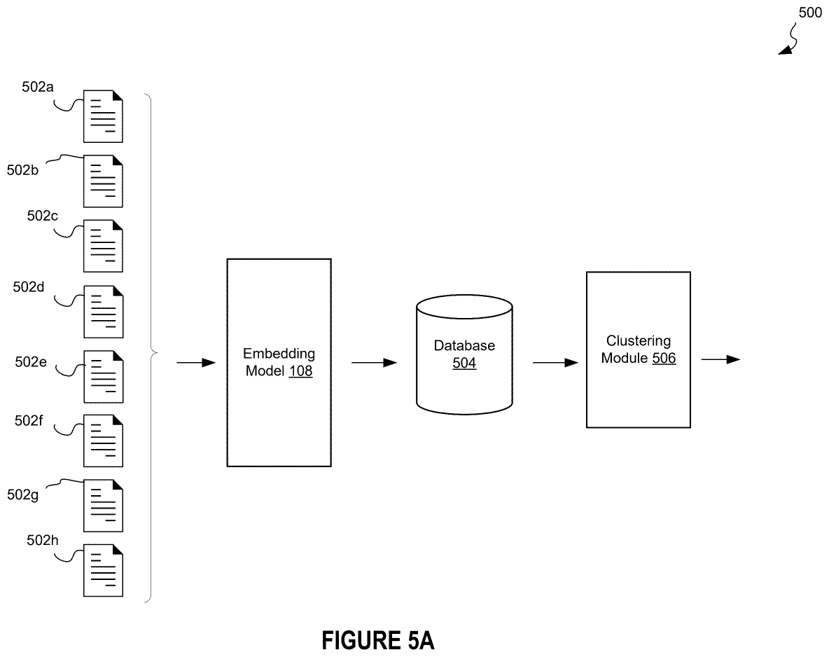

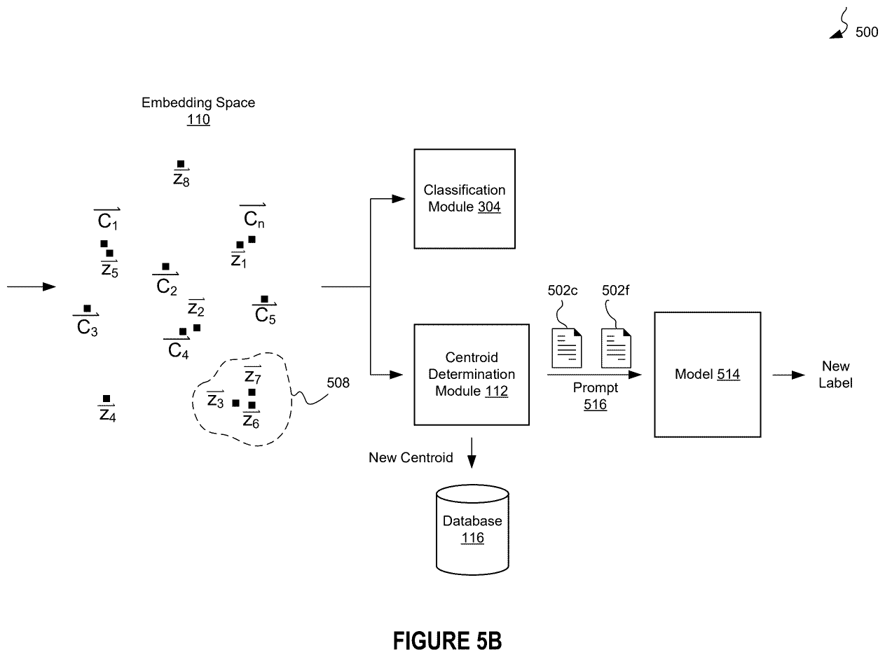

FIGS. 5A-5B illustrate an example functional block diagram 500 relating to the data management system for determination of a vector corresponding to a new custom document type, according to an embodiment of the present technology. For example, the new custom document type can be associated with sensitive data. As shown in the example of the functional block diagram 500, the data management system can include documents 502a-h, the embedding model 108, a database 504, a clustering module 506, the embedding space (or vector space) 110, the classification module 304, the centroid determination module 112, the database 116, a model 514, and a prompt 516.

The documents 502a-h can be some or all documents from a data environment, such as a customer environment. For example, the customer environment can contain documents, including documents containing unstructured data, maintained by a customer of the entity in control of the data management system. For instance, the documents can be acquired from, for example, a database, scan, or backup of data maintained for or otherwise associated with the customer. While the documents 502a-h are shown as eight documents for purposes of illustration, the documents 502a-h can be any number of documents (e.g., hundreds, thousands, millions, billions, etc.). The documents 502a-h can be associated with various document types. For example, the documents 502a-h can be associated with predetermined document types as well as new custom document types.

The documents 502a-h can be provided to the embedding model 108. The embedding model 108 can transform the documents 502a-h into, respectively, embedding vectors [symbol] . The embedding vectors [symbol] associated with the documents 502a-h can be stored in a database 504. The embedding vectors [symbol] - [symbol] associated with the documents 502a-h can be provided to the clustering module 506. The clustering module 506 can perform clustering of the embedding vectors [symbol] . The clustering performed by the clustering module 506 can be based on any suitable clustering algorithm. In some embodiments, a density based clustering algorithm can be utilized. For example, the clustering algorithm can be Hierarchical Density-Based Spatial Clustering of Applications with Noise (HDBSCAN). Based on the clustering, a new cluster 508 formed by the embedding vector [symbol] , the embedding vector [symbol] , and the embedding vector [symbol] in the embedding space 110 can be determined. In some embodiments, the clustering algorithm can be run periodically or intermittently on unclassified documents in the customer environment to potentially identify additional new clusters.

The classification module 304 can determine the extent of similarities between embedding vectors and centroids. As shown, the embedding space 110 can include the embedding vectors [symbol] . The embedding space 110 also can include centroids [symbol] associated with n predetermined document types. When the similarity threshold is satisfied as between an embedding vector and a centroid, the document associated with the embedding vector can be classified as the predetermined document type corresponding to the centroid. For example, based on the satisfaction of a selected similarity threshold, the classification module 304 can classify the document 502e, which is associated with the embedding vector [symbol] , as the predetermined document type corresponding to the centroid [symbol] ; the document 502a, which is associated with the embedding vector [symbol] , as the predetermined document type corresponding to the centroid [symbol] ; and, the document 502b, which is associated with the embedding vector [symbol] , as the predetermined document type corresponding to the centroid [symbol] . Embedding vectors associated with documents classified as predetermined document types through adjacent centroids in this manner need not be provided to the centroid determination module 112.

The new cluster 508 formed by the embedding vector [symbol] , the embedding vector [symbol] , and the embedding vector [symbol] , can be analyzed. The new cluster 508 can be determined to be distinct from other clusters represented by the centroids [symbol] . As described herein, the sufficiency of the new cluster 508 in relation to intra-cluster cohesiveness and inter-cluster separation from other clusters, such as clusters corresponding to the predetermined document types, can be determined. If applicable threshold values are satisfied by the new cluster 508, the centroid determination module 112 can generate a new vector, such as a new centroid, for the new cluster 508. The new centroid can be representative of a new custom document type to which the documents 502c, 502f, 502g associated with, respectively, embedding vectors [symbol] , correspond. The new centroid can be stored in the database 116. The new custom document type can be added to a baseline of known document types, such as predetermined document types and new document types, to result in an increased set of document types to which unclassified documents can be potentially classified. For example, a new custom document type can arise to supplement known document types when a customer environment contains categories of documents that are unique to the customer environment or not previously considered by the data management system. While determination of a single new custom document type has been discussed herein for purposes of illustration, any number of new custom document types can be determined from documents in a customer environment in a similar manner.

An embedding vector that does not satisfy the similarity threshold in relation to a centroid and that is not included in a newly formed cluster of embedding vectors can be classified as noise. As noise, the document associated with the embedding vector is not categorized into a document type. For example, as shown, because the embedding vector [symbol] and the embedding vector [symbol] do not satisfy the selected similarity threshold in relation to a centroid and are not included in a new cluster, the embedding vector [symbol] and the embedding vector [symbol] are determined to be noise. As such, the associated document 502d and the document 502h are not classified as a predetermined document type or a new custom document type.

Some or all documents corresponding to the new cluster 508 along with an appropriate prompt 516 can be provided to the model 514. The model 514 can generate a descriptive new label for the new custom document type. The model 514 can be any model suitable for generating new labels for document types. The model 514 can be or include any type of generative AI model or foundation model, such as a large language model (LLM). In some embodiments, the model 514, the model 402, and the model 102 can be the same model. The prompt 516 can be engineered and configured to cause the model 514 to generate a label that accurately describes a new custom document type. The prompt 516 (e.g., one shot, two shot, n shot) can include examples of documents of the new custom document type. As shown, the documents 502c, 502f can be submitted to the model 514 with the prompt 516. The prompt 516 can include an instruction to generate a description or label of a selected fixed length (e.g., two or three words) for the submitted documents. In some embodiments, the prompt 516 can cause generation of an accurate, distinct label for a new custom document type without specifying labels of known document types in the prompt 516. After the new label is generated for the new custom document type, the new label can be stored with the centroid representative of the new custom document type.

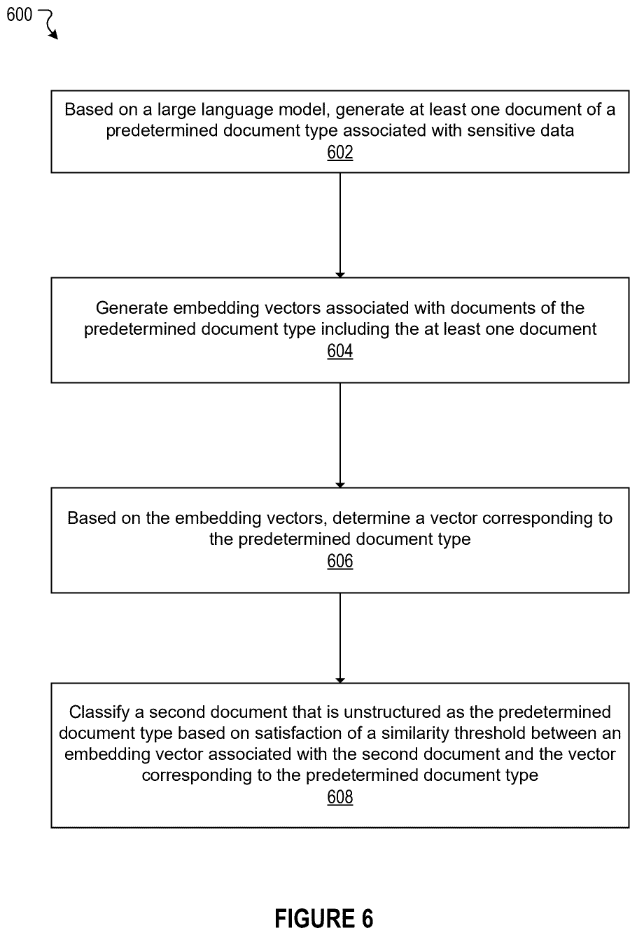

FIG. 6 illustrates an example method, according to an embodiment of the present technology. It should be understood that there can be additional, fewer, or alternative steps performed in similar or alternative orders, or in parallel, based on the various features and embodiments discussed herein unless otherwise stated. At block 602, the method 600 can, based on a large language model, generate at least one document of a predetermined document type associated with sensitive data. At block 604, the method 600 can generate embedding vectors associated with documents of the predetermined document type including the at least one document. At block 606, the method 600 can, based on the embedding vectors, determine a vector corresponding to the predetermined document type. At block 608, the method 600 can classify a second document that is unstructured as the predetermined document type based on satisfaction of a similarity threshold between an embedding vector associated with the second document and the vector corresponding to the predetermined document type.

FIG. 7 illustrates an example of a computing environment 700 in which the data management system can be implemented in accordance with the present technology. The computing environment 700 may include a computing system 705, a data management service (DMS) 710, and one or more computing devices 715, which may be in communication with one another via a network 720. The computing system 705 may generate, store, process, modify, or otherwise use associated data, and the DMS 710 may provide one or more data management services for the computing system 705. For example, the DMS 710 may provide a data backup service, a data recovery service, a data classification service, a data transfer or replication service, a malware protection service, a sensitive data classification service, and an artificial intelligence (AI) assisted generative data service. For example, the sensitive data classification service can implement or incorporate the data management system as described herein.

The network 720 may allow the one or more computing devices 715, the computing system 705, and the DMS 710 to communicate (e.g., exchange information) with one another. The network 720 may include aspects of one or more wired networks (e.g., the Internet), one or more wireless networks (e.g., cellular networks), or any combination thereof. The network 720 may include aspects of one or more public networks or private networks, as well as secured or unsecured networks, or any combination thereof. The network 720 also may include any quantity of communications links and any quantity of hubs, bridges, routers, switches, ports or other physical or logical network components.

A computing device 715 may be used to input information to or receive information from the computing system 705, the DMS 710, or both. For example, a user of the computing device 715 may provide user inputs via the computing device 715, which may result in commands, data, or any combination thereof being communicated via the network 720 to the computing system 705, the DMS 710, or both. Additionally, or alternatively, a computing device 715 may output (e.g., display) data or other information received from the computing system 705, the DMS 710, or both. A user of a computing device 715 may, for example, use the computing device 715 to interact with one or more Uls (e.g., graphical user interfaces (GUIs)) to operate or otherwise interact with the computing system 705, the DMS 710, or both. Though one computing device 715 is shown in FIG. 7, it is to be understood that the computing environment 700 may include any quantity of computing devices 715.

A computing device 715 may be a stationary device (e.g., a desktop computer or access point) or a mobile device (e.g., a laptop computer, tablet computer, or cellular phone). In some examples, a computing device 715 may be a commercial computing device, such as a server or collection of servers. And in some examples, a computing device 715 may be a virtual device (e.g., a virtual machine). Though shown as a separate device in the example computing environment of FIG. 7, it is to be understood that in some cases a computing device 715 may be included in (e.g., may be a component of) the computing system 705 or the DMS 710.

The computing system 705 may include one or more servers 725 and may provide (e.g., to the one or more computing devices 715) local or remote access to applications, databases, or files stored within the computing system 705. The computing system 705 may further include one or more data storage devices 730. Though one server 725 and one data storage device 730 are shown in FIG. 7, it is to be understood that the computing system 705 may include any quantity of servers 725 and any quantity of data storage devices 730, which may be in communication with one another and collectively perform one or more functions ascribed herein to the server 725 and data storage device 730.

A data storage device 730 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 730 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 730 may be a database (e.g., a relational database), and a server 725 may host (e.g., provide a database management system for) the database.

A server 725 may allow a client (e.g., a computing device 715) to download information or files (e.g., executable, text, application, audio, image, or video files) from the computing system 705, to upload such information or files to the computing system 705, or to perform a search related to particular information stored by the computing system 705. In some examples, a server 725 may act as an application server or a file server. In general, a server 725 may refer to one or more hardware devices that act as the host in a client-server relationship or a software process that shares a resource with or performs work for one or more clients.

A server 725 may include a network interface 740, processor 745, memory 750, disk 755, and computing system manager 760. The network interface 740 may enable the server 725 to connect to and exchange information via the network 720 (e.g., using one or more network protocols). The network interface 740 may include one or more wireless network interfaces, one or more wired network interfaces, or any combination thereof. The processor 745 may execute computer-readable instructions stored in the memory 750 in order to cause the server 725 to perform functions ascribed herein to the server 725. The processor 745 may include one or more processing units, such as one or more central processing units (CPUs), one or more graphics processing units (GPUs), or any combination thereof. The memory 750 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 755 may include one or more HDDs, one or more SSDs, or any combination thereof. Memory 750 and disk 755 may comprise hardware storage devices. The computing system manager 760 may manage the computing system 705 or aspects thereof (e.g., based on instructions stored in the memory 750 and executed by the processor 745) to perform functions ascribed herein to the computing system 705. In some examples, the network interface 740, processor 745, memory 750, and disk 755 may be included in a hardware layer of a server 725, and the computing system manager 760 may be included in a software layer of the server 725. In some cases, the computing system manager 760 may be distributed across (e.g., implemented by) multiple servers 725 within the computing system 705.

In some examples, the computing system 705 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 705 or aspects thereof through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing devices 715 over the network 720). IaaS may refer to a service in which physical computing resources are used to instantiate one or more virtual machines, the resources of which are made available to one or more client devices over a network (e.g., to one or more computing devices 715 over the network 720).

In some examples, the computing system 705 or aspects thereof may implement or be implemented by one or more virtual machines. The one or more virtual machines may run various applications, such as a database server, an application server, or a web server. For example, a server 725 may be used to host (e.g., create, manage) one or more virtual machines, and the computing system manager 760 may manage a virtualized infrastructure within the computing system 705 and perform management operations associated with the virtualized infrastructure. The computing system manager 760 may manage the provisioning of virtual machines running within the virtualized infrastructure and provide an interface to a computing device 715 interacting with the virtualized infrastructure. For example, the computing system manager 760 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 755, the memory, the processor 745, the network interface 740, the data storage device 730, or any combination thereof in support of running the various applications. Storage resources (e.g., the disk 755, the memory 750, or the data storage device 730) that are virtualized may be accessed by applications as a virtual disk.

The DMS 710 may provide one or more data management services for data associated with the computing system 705 and may include DMS manager 790 and any quantity of storage nodes 785. The DMS manager 790 may manage operation of the DMS 710, including the storage nodes 785. Though illustrated as a separate entity within the DMS 710, the DMS manager 790 may in some cases be implemented (e.g., as a software application) by one or more of the storage nodes 785. In some examples, the storage nodes 785 may be included in a hardware layer of the DMS 710, and the DMS manager 790 may be included in a software layer of the DMS 710. In the example illustrated in FIG. 7, the DMS 710 is separate from the computing system 705 but in communication with the computing system 705 via the network 720. It is to be understood, however, that in some examples at least some aspects of the DMS 710 may be located within computing system 705. For example, one or more servers 725, one or more data storage devices 730, and at least some aspects of the DMS 710 may be implemented within the same cloud environment or within the same data center.

Storage nodes 785 of the DMS 710 may include respective network interfaces 765, processors 770, memories 775, and disks 780. The network interfaces 765 may enable the storage nodes 785 to connect to one another, to the network 720, or both. A network interface 765 may include one or more wireless network interfaces, one or more wired network interfaces, or any combination thereof. The processor 770 of a storage node 785 may execute computer-readable instructions stored in the memory 775 of the storage node 785 in order to cause the storage node 785 to perform processes described herein as performed by the storage node 785. A processor 770 may include one or more processing units, such as one or more CPUs, one or more GPUs, or any combination thereof. The memory 775 may comprise one or more types of memory (e.g., RAM, SRAM, DRAM, ROM, EEPROM, Flash, etc.). A disk 780 may include one or more HDDs, one or more SDDs, or any combination thereof. Memories 775 and disks 780 may comprise hardware storage devices. Collectively, the storage nodes 785 may in some cases be referred to as a storage cluster or as a cluster of storage nodes 785.

The DMS 710 may provide a backup and recovery service for the computing system 705. For example, the DMS 710 may manage the extraction and storage of snapshots 735 associated with different point-in-time versions of one or more target computing objects within the computing system 705. A snapshot 735 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 735 may also be used to restore (e.g., recover) the corresponding computing object as of the particular point in time corresponding to the snapshot 735. A computing object of which a snapshot 735 may be generated may be referred to as snappable. Snapshots 735 may be generated at different times (e.g., periodically or on some other scheduled or configured basis) in order to represent the state of the computing system 705 or aspects thereof as of those different times. In some examples, a snapshot 735 may include metadata that defines a state of the computing object as of a particular point in time. For example, a snapshot 735 may include metadata associated with (e.g., that defines a state of) some or all data blocks included in (e.g., stored by or otherwise included in) the computing object. Snapshots 735 (e.g., collectively) may capture changes in the data blocks over time. Snapshots 735 generated for the target computing objects within the computing system 705 may be stored in one or more storage locations (e.g., the disk 755, memory 750, the data storage device 730) of the computing system 705, in the alternative or in addition to being stored within the DMS 710, as described below.

To obtain a snapshot 735 of a target computing object associated with the computing system 705 (e.g., of the entirety of the computing system 705 or some portion thereof, such as one or more databases, virtual machines, or filesystems within the computing system 705), the DMS manager 790 may transmit a snapshot request to the computing system manager 760. In response to the snapshot request, the computing system manager 760 may set the target computing object into a frozen state (e.g., a read-only state). Setting the target computing object into a frozen state may allow a point-in-time snapshot 735 of the target computing object to be stored or transferred.

In some examples, the computing system 705 may generate the snapshot 735 based on the frozen state of the computing object. For example, the computing system 705 may execute an agent of the DMS 710 (e.g., the agent may be software installed at and executed by one or more servers 725), and the agent may cause the computing system 705 to generate the snapshot 735 and transfer the snapshot 735 to the DMS 710 in response to the request from the DMS 710. In some examples, the computing system manager 760 may cause the computing system 705 to transfer, to the DMS 710, data that represents the frozen state of the target computing object, and the DMS 710 may generate a snapshot 735 of the target computing object based on the corresponding data received from the computing system 705.

Once the DMS 710 receives, generates, or otherwise obtains a snapshot 735, the DMS 710 may store the snapshot 735 at one or more of the storage nodes 785. The DMS 710 may store a snapshot 735 at multiple storage nodes 785, for example, for improved reliability. Additionally, or alternatively, snapshots 735 may be stored in some other location connected with the network 720. For example, the DMS 710 may store more recent snapshots 735 at the storage nodes 785, and the DMS 710 may transfer less recent snapshots 735 via the network 720 to a cloud environment (which may include or be separate from the computing system 705) for storage at the cloud environment, a magnetic tape storage device, or another storage system separate from the DMS 710.

Updates made to a target computing object that has been set into a frozen state may be written by the computing system 705 to a separate file (e.g., an update file) or other entity within the computing system 705 while the target computing object is in the frozen state. After the snapshot 735 (or associated data) of the target computing object has been transferred to the DMS 710, the computing system manager 760 may release the target computing object from the frozen state, and any corresponding updates written to the separate file or other entity may be merged into the target computing object.

In response to a restore command (e.g., from a computing device 715 or the computing system 705), the DMS 710 may restore a target version (e.g., corresponding to a particular point in time) of a computing object based on a corresponding snapshot 735 of the computing object. In some examples, the corresponding snapshot 735 may be used to restore the target version based on data of the computing object as stored at the computing system 705 (e.g., based on information included in the corresponding snapshot 735 and other information stored at the computing system 705, the computing object may be restored to its state as of the particular point in time). Additionally, or alternatively, the corresponding snapshot 735 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 735. For example, the target version of the computing object may be restored based on the information in a snapshot 735 and based on information included in a backup copy of the target object generated prior to the time corresponding to the target version. Backup copies of the computing object may be stored at the DMS 710 (e.g., in the storage nodes 785) or in some other location connected with the network 720 (e.g., in a cloud environment, which in some cases may be separate from the computing system 705).

In some examples, the DMS 710 may restore the target version of the computing object and transfer the data of the restored computing object to the computing system 705. And in some examples, the DMS 710 may transfer one or more snapshots 735 to the computing system 705, and restoration of the target version of the computing object may occur at the computing system 705 (e.g., as managed by an agent of the DMS 710, where the agent may be installed and operate at the computing system 705).

In response to a mount command (e.g., from a computing device 715 or the computing system 705), the DMS 710 may instantiate data associated with a point-in-time version of a computing object based on a snapshot 735 corresponding to the computing object (e.g., along with data included in a backup copy of the computing object) and the point-in-time. The DMS 710 may then allow the computing system 705 to read or modify the instantiated data (e.g., without transferring the instantiated data to the computing system). In some examples, the DMS 710 may instantiate (e.g., virtually mount) some or all of the data associated with the point-in-time version of the computing object for access by the computing system 705, the DMS 710, or the computing device 715.

In some examples, the DMS 710 may store different types of snapshots 735, including for the same computing object. For example, the DMS 710 may store both base snapshots 735 and incremental snapshots 735. A base snapshot 735 may represent the entirety of the state of the corresponding computing object as of a point in time corresponding to the base snapshot 735. An incremental snapshot 735 may represent the changes to the state—which may be referred to as the delta—of the corresponding computing object that have occurred between an earlier or later point in time corresponding to another snapshot 735 (e.g., another base snapshot 735 or incremental snapshot 735) of the computing object and the incremental snapshot 735. In some cases, some incremental snapshots 735 may be forward-incremental snapshots 735 and other incremental snapshots 735 may be reverse-incremental snapshots 735. To generate a full snapshot 735 of a computing object using a forward-incremental snapshot 735, the information of the forward-incremental snapshot 735 may be combined with (e.g., applied to) the information of an earlier base snapshot 735 of the computing object along with the information of any intervening forward-incremental snapshots 735, where the earlier base snapshot 735 may include a base snapshot 735 and one or more reverse-incremental or forward-incremental snapshots 735. To generate a full snapshot 735 of a computing object using a reverse-incremental snapshot 735, the information of the reverse-incremental snapshot 735 may be combined with (e.g., applied to) the information of a later base snapshot 735 of the computing object along with the information of any intervening reverse-incremental snapshots 735.

In some examples, the DMS 710 may provide a data classification service, a malware detection service, a data transfer or replication service, backup verification service, or any combination thereof, among other possible data management services for data associated with the computing system 705. For example, the DMS 710 may analyze data included in one or more computing objects of the computing system 705, metadata for one or more computing objects of the computing system 705, or any combination thereof, and based on such analysis, the DMS 710 may identify locations within the computing system 705 that include data of one or more target data types (e.g., sensitive data, such as data subject to privacy regulations or otherwise of particular interest) and output related information (e.g., for display to a user via a computing device 715). Additionally, or alternatively, the DMS 710 may detect whether aspects of the computing system 705 have been impacted by malware (e.g., ransomware). Additionally, or alternatively, the DMS 710 may relocate data or create copies of data based on using one or more snapshots 735 to restore the associated computing object within its original location or at a new location (e.g., a new location within a different computing system 705). Additionally, or alternatively, the DMS 710 may analyze backup data to ensure that the underlying data (e.g., user data or metadata) has not been corrupted. The DMS 710 may perform such data classification, malware detection, data transfer or replication, or backup verification, for example, based on data included in snapshots 735 or backup copies of the computing system 705, rather than live contents of the computing system 705, which may beneficially avoid adversely affecting (e.g., infecting, loading, etc.) the computing system 705.

In some examples, the DMS 710, and in particular the DMS manager 790, may be referred to as a control plane. The control plane may manage tasks, such as storing data management data or performing restorations, among other possible examples. The control plane may be common to multiple customers or tenants of the DMS 710. For example, the computing system 705 may be associated with a first customer or tenant of the DMS 710, and the DMS 710 may similarly provide data management services for one or more other computing systems associated with one or more additional customers or tenants. In some examples, the control plane may be configured to manage the transfer of data management data (e.g., snapshots 735 associated with the computing system 705) to a cloud environment 795 (e.g., Microsoft Azure or Amazon Web Services). In addition, or as an alternative, to being configured to manage the transfer of data management data to the cloud environment 795, the control plane may be configured to transfer metadata for the data management data to the cloud environment 795. The metadata may be configured to facilitate storage of the stored data management data, the management of the stored management data, the processing of the stored management data, the restoration of the stored data management data, and the like.

Each customer or tenant of the DMS 710 may have a private data plane, where a data plane may include a location at which customer or tenant data is stored. For example, each private data plane for each customer or tenant may include a node cluster 796 across which data (e.g., data management data, metadata for data management data, etc.) for a customer or tenant is stored. Each node cluster 796 may include a node controller 797 which manages the nodes 798 of the node cluster 796. As an example, a node cluster 796 for one tenant or customer may be hosted on Microsoft Azure, and another node cluster 796 may be hosted on Amazon Web Services. In another example, multiple separate node clusters 796 for multiple different customers or tenants may be hosted on Microsoft Azure. Separating each customer or tenant's data into separate node clusters 796 provides fault isolation for the different customers or tenants and provides security by limiting access to data for each customer or tenant.

The control plane (e.g., the DMS 710, and specifically the DMS manager 790) manages tasks, such as storing backups or snapshots 735 or performing restorations, across the multiple node clusters 796. For example, as described herein, a node cluster 796-a may be associated with the first customer or tenant associated with the computing system 705. The DMS 710 may obtain (e.g., generate or receive) and transfer the snapshots 735 associated with the computing system 705 to the node cluster 796a in accordance with a service level agreement for the first customer or tenant associated with the computing system 705. For example, a service level agreement may define backup and recovery parameters for a customer or tenant such as snapshot generation frequency, which computing objects to backup, where to store the snapshots 735 (e.g., which private data plane), and how long to retain snapshots 735. As described herein, the control plane may provide data management services for another computing system associated with another customer or tenant. For example, the control plane may generate and transfer snapshots 735 for another computing system associated with another customer or tenant to the node cluster 796 n in accordance with the service level agreement for the other customer or tenant.

To manage tasks, such as storing backups or snapshots 735 or performing restorations, across the multiple node clusters 796, the control plane (e.g., the DMS manager 790) may communicate with the node controllers 797 for the various node clusters via the network 720. For example, the control plane may exchange communications for backup and recovery tasks with the node controllers 797 in the form of transmission control protocol (TCP) packets via the network 720.

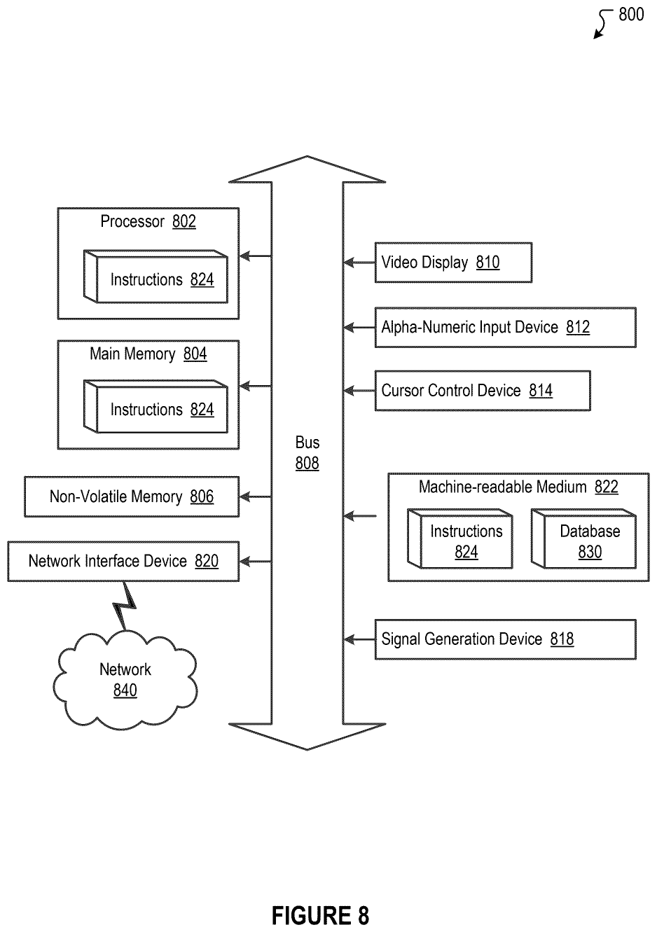

FIG. 8 illustrates an example of a computer system 800 that may be used to implement one or more of the embodiments of the present technology. For example, the computer system 800 can be implemented as a server, server system, or other type of computing system of the data management system, the system, the data management service (DMS) 710, the computing system 705, the cloud environment 795, or the computing device 715. The computer system 800 can be included in a wide variety of local and remote machine and computer system architectures and in a wide variety of network and cloud computing environments that can implement the functionalities of the present technology. The computer system 800 includes sets of instructions 824 for causing the computer system 800 to perform the functionality, features, and operations discussed herein. The computer system 800 may be connected (e.g., networked) to other machines and/or computer systems. In a networked deployment, the computer system 800 may operate in the capacity of a server or a client machine in a client-server network environment, or as a peer machine in a peer-to-peer (or distributed) network environment.

The computer system 800 includes a processor 802 (e.g., a central processing unit (CPU), a graphics processing unit (GPU), or both), a main memory 804, and a nonvolatile memory 806 (e.g., volatile RAM and non-volatile RAM, respectively), which communicate with each other via a bus 808. In some embodiments, the computer system 800 can be a desktop computer, a laptop computer, personal digital assistant (PDA), or mobile phone, for example. In one embodiment, the computer system 800 also includes a video display 810, an alphanumeric input device 812 (e.g., a keyboard), a cursor control device 814 (e.g., a mouse), a signal generation device 818 (e.g., a speaker) and a network interface device 820.

In one embodiment, the video display 810 includes a touch sensitive screen for user input. In one embodiment, the touch sensitive screen is used instead of a keyboard and mouse. A machine-readable medium 822 can store one or more sets of instructions 824 (e.g., software) embodying any one or more of the methodologies, functions, or operations described herein. The instructions 824 can also reside, completely or at least partially, within the main memory 804 and/or within the processor 802 during execution thereof by the computer system 800. The instructions 824 can further be transmitted or received over a network 840 via the network interface device 820. In some embodiments, the machine-readable medium 822 also includes a database 830.

The processor 802 can be, for example, a hardware based integrated circuit (IC) or any other suitable processing device configured to run or execute a set of instructions or a set of codes. For example, the processor 802 can include a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a graphics processing unit (GPU), a neural network processor (NNP), and/or the like.

The network 840, which can represent the network 820, can be, for example, a digital telecommunication network of servers and/or computing devices. The servers and/or computing device on the network can be connected via one or more wired or wireless communication networks (not shown) to share resources such as, for example, data storage and/or computing power. The wired or wireless communication networks between servers and/or computing devices of the network can include one or more communication channels, for example, a radio frequency (RF) communication channel(s), an extremely low frequency (ELF) communication channel(s), an ultra-low frequency (ULF) communication channel(s), a low frequency (LF) communication channel(s), a medium frequency (MF) communication channel(s), an ultra-high frequency (UHF) communication channel(s), an extremely high frequency (EHF) communication channel(s), a fiber optic communication channel(s), an electronic communication channel(s), a satellite communication channel(s), and/or the like. The network can be, for example, the Internet, an intranet, a local area network (LAN), a wide area network (WAN), a metropolitan area network (MAN), a worldwide interoperability for microwave access network (WiMAX®), any other suitable communication system, and/or a combination of such networks.

The network 840 can use standard communications technologies and protocols. Thus, the network can include links using technologies such as Ethernet, 802.11, worldwide interoperability for microwave access (WiMAX®), 3G, 4G, 5G, CDMA, GSM, LTE, digital subscriber line (DSL), etc. Similarly, the networking protocols used on the network can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 806 may also be a random access memory. The non-volatile memory 806 can be a local device coupled directly to the rest of the components in the computer system 800. A non-volatile memory that is remote from the system, such as a network storage device coupled to any of the computer systems described herein through a network interface such as a modem or Ethernet interface, can also be used.

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

In general, routines executed to implement the embodiments of the invention can be implemented as part of an operating system or a specific application, component, program, object, module, or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 800 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in the same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine or computer-readable media used to actually affect the distribution.

Some embodiments described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java™, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java™, C++, etc.) or other suitable programming languages and/or development tools. Additional examples of computer code include, but are not limited to, control signals, encrypted code, and compressed code.

For purposes of explanation, numerous specific details are set forth in order to provide a thorough understanding of the description. It will be apparent, however, to one skilled in the art that embodiments of the present technology can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in some embodiments,” “in various embodiments,” “in an example,” “in one implementation,” “in one instance,” “in some instances,” or the like means that a particular feature, design, structure, or characteristic described in connection with the embodiment is included in at least one embodiment of the present technology. The appearances of, for example, the phrases “according to an embodiment,” “in one embodiment,” “in an embodiment,” “in some embodiments,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this technology is intended to yield a patent covering numerous aspects of the invention, both independently and as an overall system, and in method, computer readable medium, and apparatus modes.

Further, each of the various elements of the invention and claims may also be achieved in a variety of manners. This technology should be understood to encompass each such variation, be it a variation of an embodiment of any apparatus (or system) embodiment, a method or process embodiment, a computer readable medium embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the present technology of the embodiments of the invention is intended to be illustrative, but not limiting, of the scope of the invention, which is set forth in the following claims.

1. A computer-implemented method comprising:
based on a large language model, generating, by a computing system, at least one document of a predetermined document type associated with sensitive data;
generating, by the computing system, embedding vectors associated with documents of the predetermined document type including the at least one document;
based on the embedding vectors, determining, by the computing system, a vector corresponding to the predetermined document type;
classifying, by the computing system, a second document that is unstructured as the predetermined document type based on satisfaction of a similarity threshold between an embedding vector associated with the second document and the vector corresponding to the predetermined document type;
based on the large language model, generating, by the computing system, a plurality of documents of a new document type in the absence of preexisting documents of the new document type, wherein
the large language model is provided with a prompt configured to cause generation of the new document type,
the prompt includes a field specifying the new document type, and
the prompt includes an instruction to generate mock text files;
generating, by the computing system, embedding vectors associated with the plurality of documents of the new document type; and
based on the embedding vectors associated with the plurality of documents of the new document type, determining, by the computing system, a vector corresponding to the new document type.

2. The computer-implemented method of claim 1, wherein the large language model is provided with a prompt indicating the predetermined document type.

3. The computer-implemented method of claim 1, wherein the vector is a centroid that is maintained in a database.

4. The computer-implemented method of claim 1, further comprising:
determining that a cluster formed by the embedding vectors associated with documents of the predetermined document type does not satisfy a cohesiveness threshold; and
based on the large language model, generating additional documents of the predetermined document type.

5. The computer-implemented method of claim 1, further comprising:
determining that a cluster formed by the embedding vectors associated with documents of the predetermined document type does not satisfy a separation threshold in relation to a second cluster formed by embedding vectors associated with documents of a second predetermined document type; and
based on the large language model, generating additional documents of the predetermined document type.

6. The computer-implemented method of claim 1, wherein a plurality of vectors including the vector correspond to a plurality of predetermined document types including the predetermined document type.

7. The computer-implemented method of claim 6, wherein the classifying comprises:
generating the embedding vector associated with the second document;
determining the satisfaction of the similarity threshold based on cosine similarity between the embedding vector associated with the second document and the vector corresponding to the predetermined document type; and
determining the second document is associated with the predetermined document type.

8. (canceled)

9. The computer-implemented method of claim 1, further comprising:
based on a density based clustering algorithm, clustering embedding vectors associated with a plurality of documents from a data environment to generate at least one cluster associated with a new document type;
determining a vector corresponding to the new document type;
providing a first subset of documents from the plurality of documents associated with embedding vectors of the at least one cluster to the large language model to generate a label descriptive of the new document type.

10. The computer-implemented method of claim 9, further comprising:
determining a second subset of documents from the plurality of documents not associated with embedding vectors of the at least one cluster;
associating the second subset of documents with at least one predetermined document type of a plurality of predetermined document types or noise.

11. A system comprising:
at least one processor; and
a memory storing instructions that, when executed by the at least one processor, cause the system to perform operations comprising:
based on a large language model, generating at least one document of a predetermined document type associated with sensitive data;
generating embedding vectors associated with documents of the predetermined document type including the at least one document;
based on the embedding vectors, determining a vector corresponding to the predetermined document type;
classifying a second document that is unstructured as the predetermined document type based on satisfaction of a similarity threshold between an embedding vector associated with the second document and the vector corresponding to the predetermined document type;
based on the large language model, generating a plurality of documents of a new document type in the absence of preexisting documents of the new document type, wherein
the large language model is provided with a prompt configured to cause generation of the new document type,
the prompt includes a field specifying the new document type, and
the prompt includes an instruction to generate mock text files;
generating embedding vectors associated with the plurality of documents of the new document type; and
based on the embedding vectors associated with the plurality of documents of the new document type, determining a vector corresponding to the new document type.

12. The system of claim 11, wherein the large language model is provided with a prompt indicating the predetermined document type.

13. The system of claim 11, wherein the vector is a centroid that is maintained in a database.

14. The system of claim 11, wherein the operations further comprise:
determining that a cluster formed by the embedding vectors associated with documents of the predetermined document type does not satisfy a cohesiveness threshold; and
based on the large language model, generating additional documents of the predetermined document type.

15. The system of claim 11, wherein the operations further comprise:
determining that a cluster formed by the embedding vectors associated with documents of the predetermined document type does not satisfy a separation threshold in relation to a second cluster formed by embedding vectors associated with documents of a second predetermined document type; and
based on the large language model, generating additional documents of the predetermined document type.

16. A non-transitory computer-readable storage medium including instructions that, when executed by at least on processor of a computing system, cause the computing system to perform operations comprising:
based on a large language model, generating at least one document of a predetermined document type associated with sensitive data;
generating embedding vectors associated with documents of the predetermined document type including the at least one document;
based on the embedding vectors, determining a vector corresponding to the predetermined document type;
classifying a second document that is unstructured as the predetermined document type based on satisfaction of a similarity threshold between an embedding vector associated with the second document and the vector corresponding to the predetermined document type;
based on the large language model, generating a plurality of documents of a new document type in the absence of preexisting documents of the new document type, wherein
the large language model is provided with a prompt configured to cause generation of the new document type.
the prompt includes a field specifying the new document type, and
the prompt includes an instruction to generate mock text files;
generating embedding vectors associated with the plurality of documents of the new document type; and
based on the embedding vectors associated with the plurality of documents of the new document type, determining a vector corresponding to the new document type.

17. The non-transitory computer-readable storage medium of claim 16, wherein the large language model is provided with a prompt indicating the predetermined document type.

18. The non-transitory computer-readable storage medium of claim 16, wherein the vector is a centroid that is maintained in a database.

19. The non-transitory computer-readable storage medium of claim 16, wherein the operations further comprise:
determining that a cluster formed by the embedding vectors associated with documents of the predetermined document type does not satisfy a cohesiveness threshold; and
based on the large language model, generating additional documents of the predetermined document type.

20. The non-transitory computer-readable storage medium of claim 16, wherein the operations further comprise:
determining that a cluster formed by the embedding vectors associated with documents of the predetermined document type does not satisfy a separation threshold in relation to a second cluster formed by embedding vectors associated with documents of a second predetermined document type; and
based on the large language model, generating additional documents of the predetermined document type.
